(19) United States
(12) Patent Application Publication
(10) Pub. No.: US 2009/0052836 A1
(43) Pub. Date: Feb. 26, 2009

(54) Optical Fiber Data Link

(75) Inventor: Malcolm H. Hodge, Chicago, IL (US)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/224,739

(22) PCT Filed: Mar. 6, 2006
(86) PCT No.: PCT/US2006/007882

§ 371 Date: Oct. 31, 2008

(51) Int. Cl. G02B 6/12; G02B 6/26

(52) U.S. Cl. 385/14; 385/43

(57) ABSTRACT

A data link for transmitting data between first and second optically active devices, such as in articulated electronic devices. A coupling unit is mounted above each optically active device. Each coupling unit has a convexly tapered well extending between a top surface and a bottom surface, with a larger opening in the top surface and a smaller opening at the bottom surface. The tapered well receives one end of the optical fiber and aligns the end with the corresponding optically active device. The smaller opening of the well may have a circular cross-section or a keyhole cross-section. A groove may be disposed near a top surface of each coupling unit, with the groove extending between the tapered well and a sidewall of the coupling unit. A segment of the optical fiber disposed near an end curves along the contour of the convexly tapered sidewalls when the optical fiber is inserted into the groove. A pair of opposed lips retain the optical fiber in the groove.

### FIELD OF THE INVENTION

The present invention relates generally to an optical data link for coupling signals between portions of an electronic device.

More particularly, the present invention relates to providing an optical fiber data link, which may include passing the optical fiber through an articulated joint of an electronic device to provide communication between separate portions of the device.

### BACKGROUND OF THE INVENTION

Cellular telephones are frequently of the so-called flip phone or clam shell configuration, having two separate portions connected together by a hinge. Laptop computers, personal digital assistants (PDAs) and other articulated electronic devices may also have portions which are hinged or articulated with respect to each other. These articulated portions are typically equipped with video or informational screens, keyboards, cameras, input/output ports and the like, that require large quantities of data to be transmitted from one portion of the electronic device to the other portion, such as through a hinge or articulation joint. For example, it may be necessary to provide 80, or more, parallel copper lines through a hinge between the portions of some articulated electronic devices. However, space and interference considerations of placing as many as 80, or more, copper lines through the hinge of an electronic device can be formidable, particularly as these devices tend to become more compact.

The issues of deploying optical fibers through the hinge, attaching optical fibers efficiently to the corresponding active optical devices and the durability of optical fibers with respect to the hinge articulation all call for creative thinking in resolving these requirements in a cost-effective manner.

There has therefore been a need for an improved means of efficiently and effectively providing communication between articulated portions of an electronic device.

A general object of the present invention is to provide an optical fiber through the hinge of an electronic device to facilitate communication between portions of the device.

Another object of the present invention is to provide an optical fiber through the hinge of an electronic device that can repeatedly flex up to 180 degrees with little or no optical degradation of the optical fiber.

A further object of the present invention is to provide an optical data link for communication between portions of an articulated electronic device that greatly reduces the number of copper lines otherwise required.

Yet another object of the present invention is to provide an optically efficient and low profile optical data link.

A still further object of the present invention is to provide means for imposing the desired radius of curvature to the optical fiber in a coupling unit disposed above an optically active device.

Another object of the present invention is to provide a coupling unit that connects an end of the optical fiber at an optically active device with minimal height requirements and minimal space requirements.

A further object of the present invention is to provide easy and efficient methods for assembling an optical data link.

### SUMMARY OF THE INVENTION

The present invention is concerned with an optical data link for transmitting data between a first portion and a second portion of an electronic device, such as an electronic device which has an articulated joint or hinge. The first portion of the electronic device includes a first circuit board and the second portion of the electronic device includes a second circuit board. A first optically active device is mounted on the first circuit board in the first portion of the electronic device and a second optically active device, or fiber optic interconnection device, is mounted on the second circuit board in the second portion of the electronic device. A first coupling unit is mounted adjacent to the first optically active device and the first coupling unit receives and holds the first end of the optical fiber in alignment with the first optically active device. Similarly, a second coupling unit is mounted adjacent to the second optically active device and the second coupling unit receives and holds the second end of the optical fiber in alignment with the second optically active device. An intermediate portion of the optical fiber passes through the articulated joint of the electronic device such that the optical data link communicates data between the first and second portions of the electronic device.

Preferably, each of the coupling units has a tapered well, with a larger opening in the top surface of the coupling unit for receiving the optical fiber into the well, and a smaller opening at a bottom surface of the coupling unit for aligning one end of the optical fiber with an optically active device. The tapered well may have convexly tapered sidewalls. For example, a portion of the convexly tapered sidewalls may define a radius as small as about 2 mm. The smaller opening at the bottom surface of each coupling unit may have a generally circular cross-section. Alternatively, the smaller opening at the bottom surface of each coupling unit may define a generally keyhole cross-section, with the keyhole cross-section having a larger opening adjoining a smaller opening at points of reduced dimension along their respective perimeters. The dimensions of the smaller opening may be configured to match the diameter of the optical fiber so that precise placement of the fiber end adjacent to the active device may be readily achieved without compromising ease of fiber insertion into the coupling unit during assembly. Further, the smaller opening may be disposed at 180 degrees to the fiber deployment direction so that the natural resistance of the fiber to bending impels the fiber into the smaller more diameter-precise opening. The smaller opening preferably offers an interference fit with the optical fiber, thereby ensuring fiber retention.

A groove may be disposed near a top surface of each coupling unit, with the groove extending between the tapered well and a sidewall of the coupling unit. A segment of the optical fiber disposed near one of the ends then curves along the contour of the convexly tapered well when the optical fiber is inserted into the groove. A pair of opposed lips may be disposed above the groove in each coupling unit, with the distance between the opposed lips being less than the width of the groove such that the opposed lips retain the optical fiber in the groove.

The present invention further includes a low-profile optical data link for transmitting data between a first optically active device and a second optically active device or fiber optic interconnection device. The low-profile optical data link includes an optical fiber with a first end and a second end, a first coupling unit for mounting above the first optically active device, the first coupling unit having a tapered well extending between a top surface and a bottom surface of the first coupling unit, the tapered well having a larger opening in the top surface and a smaller opening at the bottom surface, the tapered well receives a first end of the optical fiber and aligns the first end of the optical fiber with the first optically active device, and a second coupling unit for mounting above the second optically active device, the second coupling unit having a tapered well extending between a top surface and a bottom surface of the second coupling unit, the tapered well having a larger opening in the top surface and a smaller opening at the bottom surface, the tapered well receives a second end of the optical fiber and aligns the second end of the optical fiber with the second optically active device.

The tapered well in the coupling units for the low profile data link preferably has convexly tapered sidewalls, with a portion of the tapered sidewalls defining a radius of about 2 mm. The smaller opening at the bottom surface may have a generally circular cross-section or a generally keyhole cross-section. The keyhole cross-section has a larger opening adjoining a smaller opening at points of reduced dimension along their respective perimeters. The dimensions of the smaller opening may be configured to match the diameter of the optical fiber so that precise placement of the fiber end adjacent to the active device may be readily achieved without compromising ease of fiber insertion into the coupling unit during assembly. Further, the smaller opening may be disposed at 180 degrees to the fiber deployment direction so that the natural resistance of the fiber to bending impels the fiber into the smaller more diameter-precise opening. The smaller opening preferably offers an interference fit with the optical fiber, thereby ensuring fiber retention.

A groove may be disposed near a top surface of each coupling unit, with the groove extending between the tapered well and a sidewall of the coupling unit. A segment of the optical fiber disposed near one of the ends curves along the contour of the convexly tapered sidewalls when the optical fiber is inserted into the groove. A pair of opposed lips may be disposed above the groove in each coupling unit, the distance between the opposed lips being less than the width of the groove such that the opposed lips retain the optical fiber in the groove.

The present invention is also directed to a coupling unit for receiving and holding an optical fiber in alignment with an optically active device in an optical data link. The coupling unit includes a tapered well extending between a top surface and a bottom surface of the coupling unit, with the tapered well having a larger opening in the top surface of the coupling unit for receiving the optical fiber and with the tapered well having a smaller opening at the bottom surface of the coupling unit for aligning an end of the optical fiber with the optically active device.

The tapered well may have convexly tapered sidewalls. A portion of the convexly tapered sidewalls may define a radius of about 2 mm. The smaller opening at the bottom of the coupling unit may have a generally circular in cross-section or a generally keyhole cross-section. The keyhole cross-section has a larger opening adjoining a smaller opening at points of reduced dimension along their respective perimeters. The dimensions of the smaller opening may be configured to match the diameter of the optical fiber so that precise placement of the fiber end adjacent to the active device may be readily achieved without compromising ease of fiber insertion into the coupling unit during assembly. Further, the smaller opening may be disposed at 180 degrees to the fiber deployment direction so that the natural resistance of the fiber to bending impels the fiber into the smaller more diameter-precise opening. The smaller opening preferably offers an interference fit with the optical fiber, thereby ensuring fiber retention.

A groove may be disposed near a top surface of the coupling unit, with the groove extending between the tapered well and a sidewall of the coupling unit. A segment of the optical fiber disposed near the end curves along the contour of the tapered well when the optical fiber is inserted into the groove. A pair of opposed lips may be disposed above the groove in the coupling unit, with the distance between the opposed lips being less than the width of the groove such that the opposed lips retain the optical fiber in the groove.

The present invention further contemplates easy and efficient methods for assembling a portion of an optical data link of the type that includes a coupling unit and an optical fiber, and the coupling unit includes a tapered well with a larger end and a smaller end and a groove extending from the well to a sidewall of the coupling unit. The method includes the steps of inserting one end of the optical fiber into the larger end of the well of the coupling unit, bending the optical fiber through about 90 degrees; and pressing the optical fiber into the groove of the coupling unit. Additional steps may include controlling the curvature of the optical fiber by bending the fiber against the curved walls of the well, retaining the optical fiber in the groove by providing an interference fit, providing a keyhole design at the smaller end of the well with said keyhole design having a larger opening and a smaller opening, inserting the optical fiber into the larger opening of the keyhole design, and impelling the end of the optical fiber from the larger opening into the smaller opening of the keyhole design to provide an interference fit at the end of the optical fiber during cutting or cleaving of the end of the fiber.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1A is a perspective view illustrating a prior art laptop computer into which the present invention may be incorporated;

FIG. 1B is an elevational view of a prior art cellular telephone of the flip phone or clam shell configuration into which the present invention may be incorporated;

FIG. 1C is a side view of the prior art cellular telephone shown in FIG. 1B;

FIG. 2 is a perspective view illustrating a low-profile optical data link suitable for the laptop computer shown FIG. 1A or for the cellular telephone shown in FIGS. 1B-1C in accordance with a preferred embodiment of the present invention;

FIG. 3 is an enlarged top perspective view of one of the optical fiber coupling units shown in FIG. 2;

FIG. 4 is a perspective view of the low-profile optical data link shown in FIG. 2 from a different perspective;

FIG. 5 is an enlarged side perspective view of one of the optical fiber coupling units shown in FIGS. 2 and 4;

FIG. 6 is another enlarged side perspective view of one of the optical fiber coupling units shown in FIGS. 2 and 4;

FIG. 7 is a diagrammatic view of a keyhole configuration for retaining an end of the optical fiber in a coupling unit at an optically active device;

FIG. 8 is an enlarged bottom plan view of an optical fiber coupling unit which utilizes the keyhole configuration shown in FIG. 7;

FIG. 9 is an enlarged perspective view of the optical fiber coupling unit shown in FIG. 8; and

FIG. 10 is an enlarged top plan view of the optical fiber coupling unit shown in FIGS. 8 and 9.

### DESCRIPTION OF THE PREFERRED EMBODIMENTS

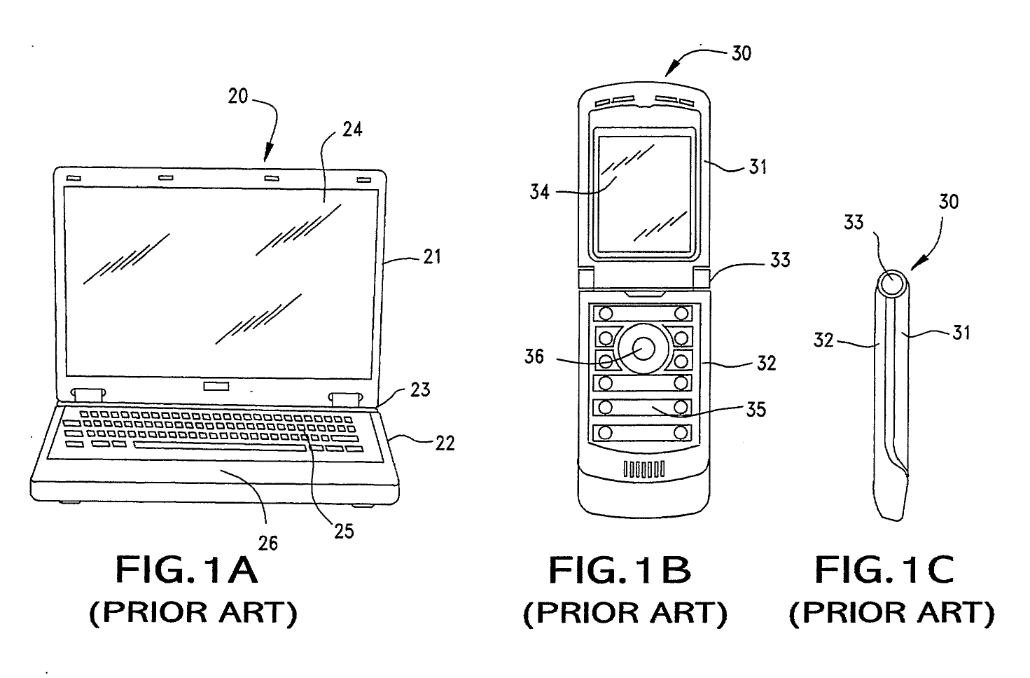

FIGS. 1A, 1B and 1C illustrate representative electronic devices having a hinged or articulated joint. For example, FIG. 1A illustrates a typical laptop computer, generally designated 20, with an upper portion 21, a lower or base portion 22 and a hinge 23 which permits the upper portion 21 to be rotated relative to the lower portion 22, including for opening and closing the laptop computer 20. Upper portion 21 typically includes a display 24. Lower portion 22 typically includes an alpha-numeric keyboard 25, control keys 26 and input and output ports (not shown) along the sides and back thereof. In addition, the lower portion 22 usually includes a battery, a CD/DVD player/burner, a port for an internet network card, and the like. Thus, considerable amounts of information must be routed between different portions of the laptop computer 20, including through the hinge 23. To this end, significant numbers of copper lines are typically disposed on a flexible substrate or membrane, which is routed through hinge 23 to provide for a plurality of electrical signals, and for electrical power and ground connections between the upper and lower portions 21 and 22.

FIG. 1B illustrates a typical cellular telephone, generally designated 30, of the so-called flip phone or clam shell type. Cellular telephones of this type consist of an upper portion 31 connected to a lower portion 32 by means of an articulated joint, such as a hinge 33. The upper portion 31 may include a screen 34. The lower portion 32 typically includes a keypad 35 and a plurality of controls 36, such as for initiating functions, scrolling the display and the like. As shown in FIG. 1C, the upper portion 31 may be folded into the lower portion 32 by rotation about the hinge 33. In a manner similar to the laptop computer 20, the cellular telephone 30 requires some means of communication between the upper portion 31 and the lower portion 32, such as a flexible membrane with a plurality of copper conductors internally routed through the hinge 33.

Of course, other types of electronic devices besides the laptop computer 20 and cellular telephone 30 shown in FIGS. 1A-1C may have hinges or articulated joints between portions of the device. For example, hand-held entertainment devices, PDAs, other portable electronic devices and the like may also utilize the present invention to communicate between the respective portions.

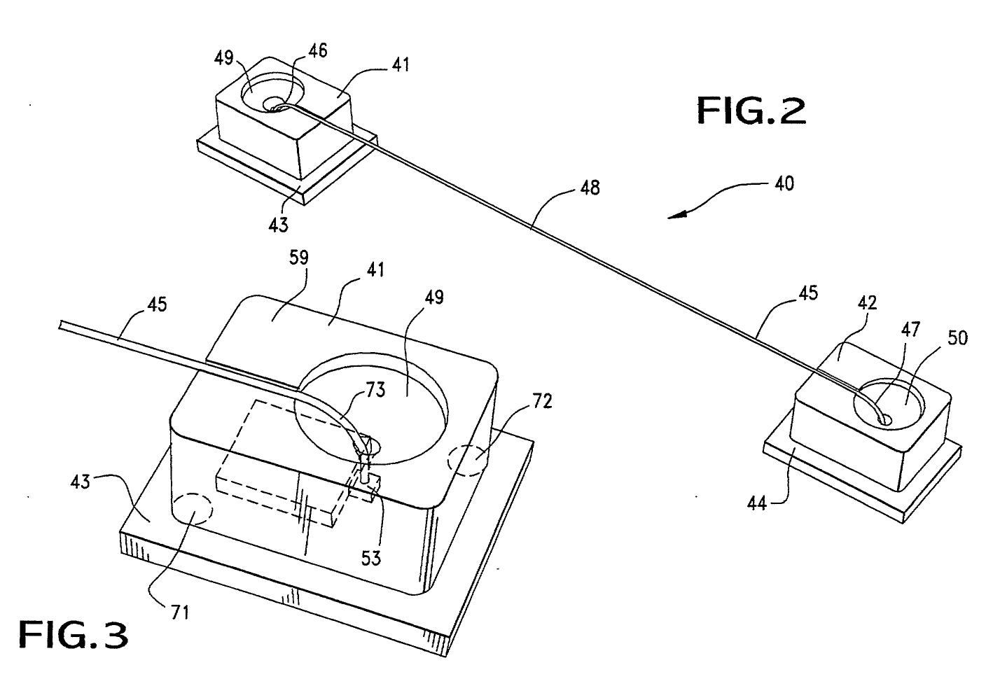

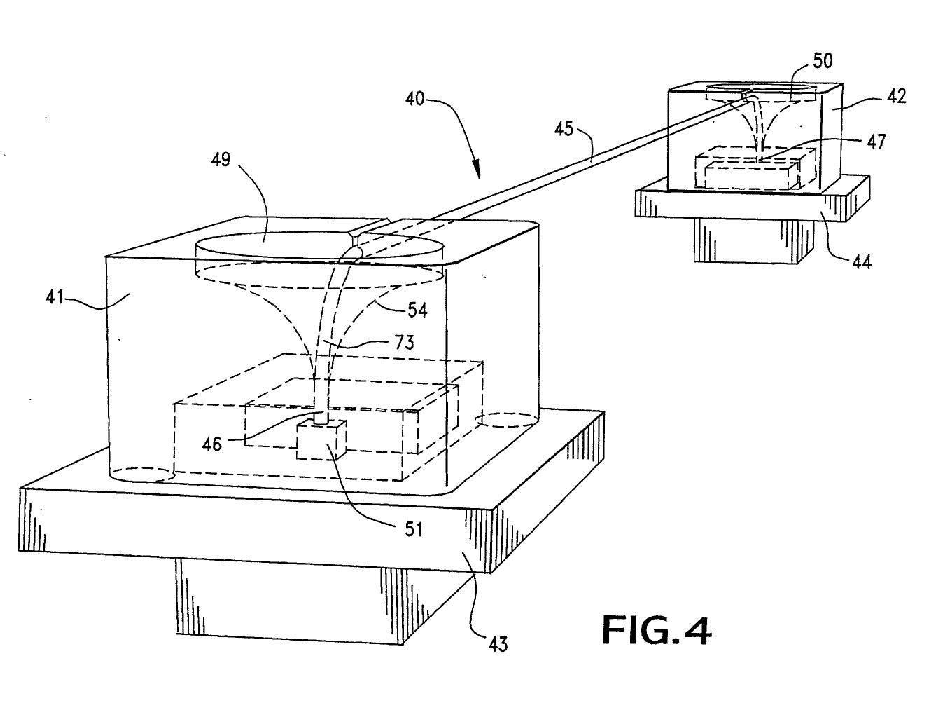

In accordance with one aspect of the present invention, a low-profile optical data link, generally designated 40, is shown in FIGS. 2 and 4. For example, optical data link 40 is especially suited for transmitting data between portions of an electronic device, such as between the upper and lower portions 21 and 22 of laptop computer 20 or between upper and lower portions 31 and 32 of cellular telephone 30. A first coupling unit 41 is mounted on a portion of a first printed circuit board (PCB) 43, which may be contained within the upper portion 21 of laptop computer 20 or within the upper portion 31 of cellular telephone 30. Similarly, a second coupling unit 42 is mounted on a portion of a second PCB 44, which may be contained within the lower portion 22 of laptop computer 20 or within the lower portion 32 of cellular telephone 30.

An optical fiber 45 extends between the first coupling unit 41 and the second coupling unit 42 to transmit data between PCBs 43 and 44. With respect to use of the present invention in the devices shown in FIGS. 1A-1C, it will be appreciated that an intermediate portion 48 of optical fiber 45 will be disposed in the hinge 23 of laptop 20 or in the hinge 33 of cellular telephone 30.

Optical fiber 45 is preferably a small diameter plastic optical fiber (POF), which assists in resolving any flexibility and articulation issues. For example, plastic optical fibers with an outside diameter (OD) of about 250 micrometers down to about 125 micrometers are capable of surviving many hundreds of thousands of 180° flexes, both at room temperature and at −40° C., with little or no optical degradation with a bend radius of about 2 mm or less. Further, optical degradation losses of such POFs from repetitive 360° bends with a radius of about 0.75 mm is typically only about 1 dB.

FIGS. 3, 5 and 6 have enlarged views of the optical coupling units, such as optical coupling units 41 and 42 shown in FIGS. 2 and 4. Optical coupling unit 41 will be presented in further detail. It is understood that optical coupling unit 42 may be generally similar or identical to optical coupling unit 41. An optically active device 53 (FIGS. 3 and 6), such as a laser or resonant cavity light emitting diode (RCLED), is mounted flat and stably to the PCB 43. Optical coupling unit 41 may have a pair of pegs 71 and 72 (FIG. 3), or other means, for accurately positioning coupling unit 41 on the PCB 43 and for indexing the coupling unit 41 relative to the active device 53.

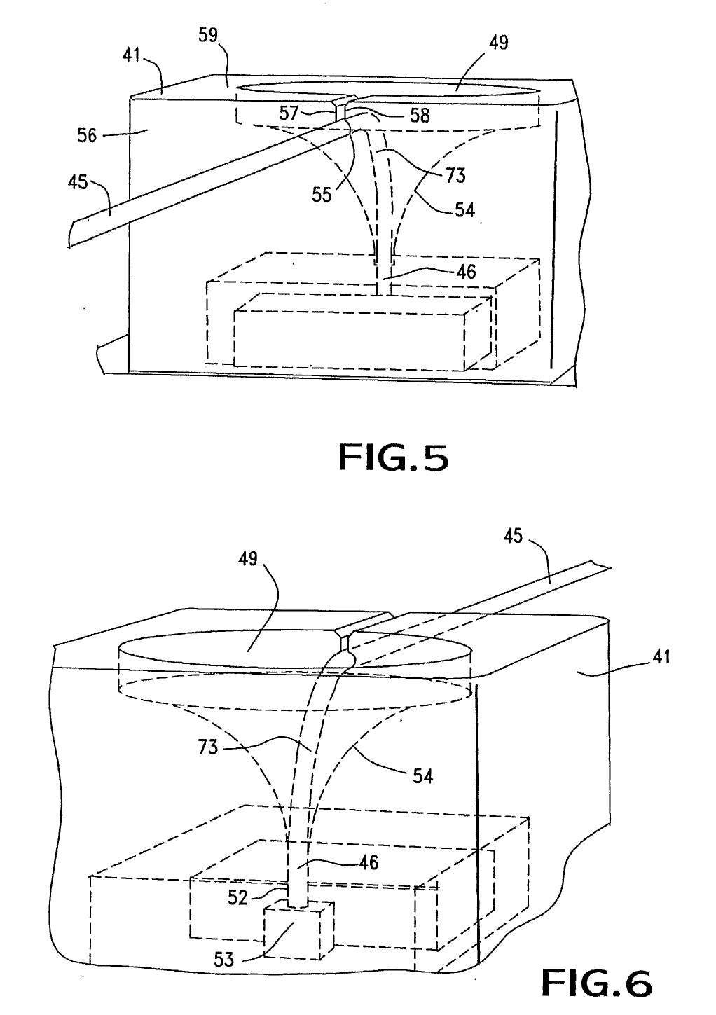

Extending downwardly through the top surface 59 of optical coupling unit 41 is a well 49, which decreases in diameter until it approximates the diameter of the end 46 of the optical fiber 45. That is, as seen from the interior of well 49, the wall is convexly tapered from the top to near the end 46 of the optical fiber 45. For example and as best seen in FIGS. 5 and 6, the sidewall 54 of the well 49 may consist of a radius, which may vary depending upon the height of coupling unit 41. For example, for low-profile applications, the radius of the sidewall 54 may be as small as 2 mm if virtually no signal loss is desired. However, if some signal loss can be tolerated, the radius of sidewall 54 can be made even less than 2 mm.

As seen in FIG. 5, a groove 55 extends generally horizontally near the top surface 59 of the coupling unit, from the well 49 to an external side face 56 of unit 41. Disposed above groove 55 may be a pair of opposed lips 57 and 58, with the distance between the lips 57-58 being slightly less than that of the diameter of groove 55 and slightly less than the diameter of the optical fiber 45.

One of the ends 46 of the optical fiber 45 can be inserted into the well 49 until it is in a terminal or bottom end 52 of well 49 near the optically active device 53 and in generally orthogonal relationship thereto. The coupling unit 41 thus creates a fiber-to-device alignment. The coupling unit also allows the fiber to then be bent though about 90° against the sidewall 54 within the well 49 of the coupling unit structure. A segment 73 of the optical fiber 45 near the end 46 then assumes the curvature of the sidewall 54 of the well 49. The optical fiber 45 may then be anchored in place by pressing the fiber past the opposing lips 57-58 and into the groove 55, such as by a roller. The opposing lips 57-58 above the groove 55 of the coupling unit 41 thereafter effectively trap a portion of the POF 45 in groove 55, such that gluing or other mechanically stabilizing means are not required during assembly. The structure of the coupling unit thus optimizes the coupling between the active device 53 and the POF 45 so that there is little to no signal loss at the interface therebetween.

Depending upon any height limitations for the coupling unit 41, or the required z-axis profile, the bend of the POF 45 within the coupling unit 41 can be as small as 2 mm when virtually no signal loss is desired, or decreased further to less than 2 mm if some signal loss is acceptable.

The very low loss of the optical data link 40 allows the active devices 53 to be run at minimal power, thus conserving critical battery power and optimizing useful life of the battery between charging cycles.

Notably absent from the structure of the optical data link 40 are any lenses, TIRs or prisms. This reduces the cost and complexity of the coupling units 41 and 42, while also maximizing optical performance. Coupling units 41-42 may be economically molded from low cost filled plastics and do not require any special optical qualities. They may also be of a small size and a low profile for occupying minimal PCB space. Material costs are thus minimal. The present invention thus provides a simple and optically efficient low-profile optical data link.

As suggested above, the structure of the coupling units 41-42 also simplifies assembly of the optical data link 40 since the assembly procedure is easy and foolproof. The POF 45 is inserted into the well 49, rotated about 90°, and pressed into groove 55, where it remains mechanically secured to the coupling unit 41 or 42.

Other than to square cut the end 46 of POF 45, such as by using the underside of the coupling unit as a guide, no special fiber preparation is required. For example, cutting the end of the POF with a hot knife will typically produce an acceptable fiber end finish. This same concept is applicable to glass optical fibers and plastic clad glass fibers. However, for glass fibers, polishing of the cleaved end is typically performed after cleaving to provide an acceptable fiber end finish. For all types of optical fibers, the fiber end may be more permanently fixed in the keyhole by dispensing a small amount of UV-curable epoxy into the well around the fiber and curing by UV exposure. The presence of epoxy also benefits the polishing process.

The other end 47 of the POF 45 is then routed through the hinge 23 or 33 of the electronic device 20 or 30, where the POF 45 may or may not be attached to a flex, prior to attachment to the other coupling unit 42. Assembly of the optical data link 40 of the present invention within an electronic device 20 or 30 may simplify assembly operations as compared to a conventional multiple copper line flex. POF 45 also provides optimal durability during “flipping” or rotating one portion of the electronic device relative to the other portion.

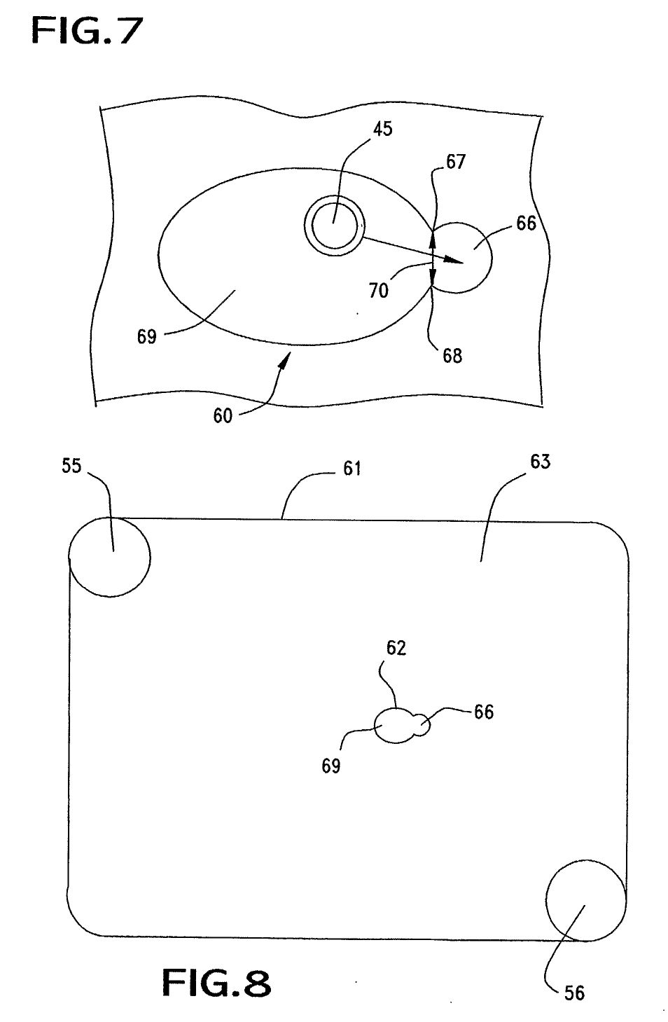

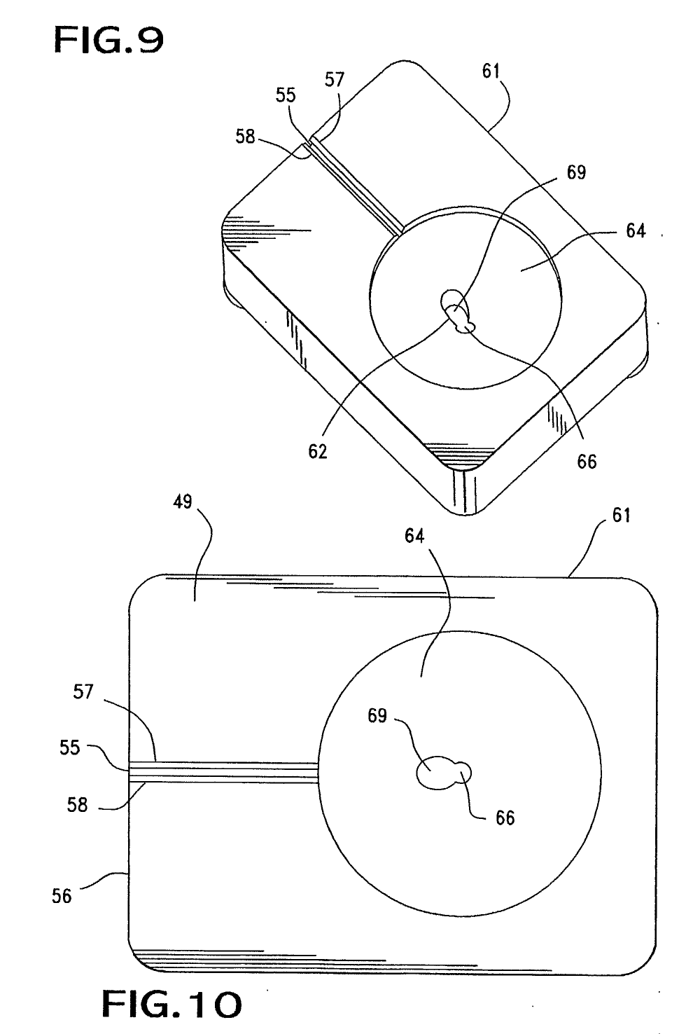

FIG. 7 illustrates an alternate embodiment “keyhole” design, generally designated 60, for a terminal or bottom end 62 near the bottom surface 63 (FIG. 8) of a coupling unit 61 shown in FIGS. 8-10. In the previously described coupling units 41 and 42, the well 49 (FIG. 6) tapers down to a terminal or bottom end 52 which is circular in cross-section. In coupling unit 41, the bottom end 52 at the bottom surface of coupling unit 41 is about, or slightly larger than, the diameter of the optical fiber 45. However, as seen in FIG. 7, the keyhole design 60 has a larger generally oval opening 69 through which optical fiber 45 may be more easily inserted. Along one end of opening 69 is a smaller and generally circular opening 66. Between openings 66 and 69 is an area of reduced dimension 70 between points 67 and 68 where openings 66 and 69 are joined along their respective perimeters. This reduced dimension 70 is preferably somewhat smaller than the diameter of the optical fiber 45 to retain the optical fiber in the smaller opening 66.

Preferably, the diameter of opening 66 is an extremely close dimensional fit to the diameter of the optical fiber 45, so as to optimize fiber-to-device alignment when the fiber is held in opening 66. The bending action of the fiber 45 within the tapered well 64 will always result in the fiber's proximal end being biased away from the re-entrant groove entrapment zone 55. It is therefore possible to expand the alignment hole to the keyhole shape 60 of the terminal end 62, where the narrowest part or opening 66 accommodates and retains the fiber end and the wider part or opening 69 allows ready and easy insertion of the POF 45. Note that POF 45 can distort during fiber end preparation, making this keyhole design 60 doubly useful.

During assembly, the optical fiber 45 is inserted through the keyhole's larger opening 69 of the terminal end 62 and bent over and trapped in the re-entrant groove 55. The proximal fiber portion may then be cut with an action impelling the POF 45 into the re-entrant narrower opening 66 of the keyhole terminal end 62. As previously discussed with respect to coupling units 41 and 42, a segment 73 of the optical fiber 45 near the end 46 will then similarly assume the curvature of the sidewall of the well 64 in coupling unit 61. By engineering an interference fit in the narrower opening 66, the ultimate mechanical stability of the POF 45 within the coupling unit 61 is assured. The relatively rugged keyhole-shape 60 of the terminal end 62 also enhances the practicality and ability of molding the coupling unit 61 precisely, as compared to closer tolerances that may be needed for the circular terminal end 52 of coupling units 41 or 42.

While a single coupling unit 61 has been discussed relative to FIGS. 7-10, it will be appreciated that two coupling units 61 will be required in many applications to create a low-profile optical data link, such as link 40 in FIG. 4, with one coupling unit 61 connected to each end of optical fiber 45. However, there may be some applications for a single coupling unit 61, or for a single coupling unit 41, where one end of the optical fiber comes from another source and only one low-profile coupling unit is needed at the other end of POF 45. Coupling unit 61 may retain certain features of coupling units 41 and 42 such as the groove 55 extending generally horizontally near the top surface 59 of the coupling unit, from the well 64 to an external side face 56 of unit 61. Similarly, a pair of opposed lips 57 and 58 may be disposed above the groove 55, with the distance between the lips 57-58 being slightly less than that of the diameter of groove 55, such that a portion of optical fiber 54 may be pressed into the groove 55 and retained therein.

Other methods for keeping the fiber 45 in place without damaging or stressing it may also be used. By way of example only, the fiber 45 may also be kept in place by using a UV curable index matching epoxy, a piece of self-adhesive aluminum foil, or a cover snapped or press-fit into the body of the coupling unit 61. Various other options may also be apparent to those skilled in the art.

While particular embodiments of the invention have been shown and described, it will be obvious to those skilled in the art that changes and modifications may be made therein without departing from the invention in its broader aspects.

1. An optical data link for transmitting data between a first portion and a second portion of an electronic device, the first portion of said electronic device including a first circuit board and the second portion of said electronic device including a second circuit board, said portions of the electronic device connected by an articulated joint, said optical data link comprising:
an optical fiber having a first end, a second end and an intermediate portion disposed between the first and second ends;
a first optically active device mounted on the first circuit board in the first portion of the electronic device;
a second optically active device mounted on the second circuit board in the second portion of the electronic device;
a first coupling unit mounted adjacent to said first optically active device, said first coupling unit receiving and holding the first end of the optical fiber in alignment with the first optically active device;
a second coupling unit mounted adjacent to said second optically active device, said second coupling unit receiving and holding the second end of the optical fiber in alignment with the second optically active device; and
said intermediate portion of the optical fiber passing through said articulated joint of the electronic device such that said optical data link communicates data between the first and second portions of the electronic device.

2. The optical data link in accordance with claim 1, each of said first and second coupling units having a tapered well having a larger opening in a top surface of each of the coupling units for receiving the optical fiber therein, said tapered well having a smaller opening at a bottom surface of each coupling unit for aligning one end of the optical fiber with one of the optically active devices.

3. The optical data link in accordance with claim 2, said tapered well having convexly tapered sidewalls.

4. The optical data link in accordance with claim 3, a portion of said convexly tapered sidewalls defines a radius of about 2 mm.

5. The optical data link in accordance with claim 3, said smaller opening at the bottom surface of each coupling unit has a generally circular cross-section.

6. The optical data link in accordance with claim 3, said smaller opening at the bottom surface of each coupling unit has a generally keyhole cross-section, the keyhole cross-section having a larger opening adjoining a smaller opening at points of reduced dimension.

7. The optical data link in accordance with claim 2, further comprising a groove disposed near a top surface of each coupling unit, said groove extending between the tapered well and a sidewall of each coupling unit, a segment of the optical fiber disposed near one of the ends curves along the tapered well when the optical fiber is inserted into the groove.

8. The optical data link in accordance with claim 7, further comprising a pair of opposed lips disposed above the groove in each coupling unit, the distance between the opposed lips being less than the width of the groove such that the opposed lips retain the optical fiber in the groove.

9. A low-profile optical data link for transmitting data between a first optically active device and a second optically active device, said low-profile optical data link comprising:
an optical fiber having a first end and a second end;
a first coupling unit for mounting above said first optically active device, said first coupling unit having a tapered well extending between a top surface and a bottom surface of the first coupling unit, said tapered well having a larger opening in the top surface and a smaller opening at the bottom surface, said tapered well for receiving a first end of the optical fiber and for aligning the first end of the optical fiber with the first optically active device; and
a second coupling unit for mounting above said second optically active device, said second coupling unit having a tapered well extending between a top surface and a bottom surface of the second coupling unit, said tapered well having a larger opening in the top surface and a smaller opening at the bottom surface, said tapered well for receiving a second end of the optical fiber and for aligning the second end of the optical fiber with the second optically active device.

10. The low-profile optical data link in accordance with claim 9, said tapered well has convexly tapered sidewalls.

11. The low-profile optical data link in accordance with claim 10, a portion of said tapered sidewalls defines a radius of about 2 mm.

12. The low-profile optical data link in accordance with claim 9, said smaller opening at the bottom surface has a generally circular cross-section.

13. The low-profile optical data link in accordance with claim 9, said smaller opening at the bottom surface has a generally keyhole cross-section, the keyhole cross-section having a larger opening adjoining a smaller opening at points of reduced dimension.

14. The low-profile optical data link in accordance with claim 10, further comprising a groove disposed near a top surface of each coupling unit, said groove extending between the tapered well and a sidewall of the coupling unit, a segment of the optical fiber disposed near one of the ends curves along the convexly tapered sidewalls when the optical fiber is inserted into the groove.

15. The low-profile optical data link in accordance with claim 14, further comprising a pair of opposed lips disposed above the groove in each coupling unit, the distance between the opposed lips being less than the width of the groove such that the opposed lips retain the optical fiber in the groove.

16. A coupling unit for receiving and holding an optical fiber in alignment with an optically active device in an optical data link, said coupling unit comprising:
a tapered well extending between a top surface and a bottom surface of the coupling unit, with the tapered well having a larger opening in the top surface of the coupling unit for receiving the optical fiber therein and with the tapered well having a smaller opening at the bottom surface of the coupling unit for aligning an end of the optical fiber with the optically active device.

17. The coupling unit in accordance with claim 16, said tapered well having convexly tapered sidewalls.

18. The coupling unit in accordance with claim 17, a portion of said convexly tapered sidewalls defining a radius of about 2 mm.

19. The coupling unit in accordance with claim 16, said smaller opening at the bottom of the coupling unit has a generally circular in cross-section.

20. The coupling unit in accordance with claim 16, said smaller opening at the bottom of the coupling unit has a generally keyhole cross-section, the keyhole cross-section having a larger opening adjoining a smaller opening at points of reduced dimension.

21. The coupling unit in accordance with claim 17, further comprising a groove disposed near a top surface of the coupling unit, said groove extending between the tapered well and a sidewall of the coupling unit, a segment of the optical fiber disposed near the end curves along the tapered well when the optical fiber is inserted into the groove.

22. The coupling unit in accordance with claim 21, further comprising a pair of opposed lips disposed above the groove in the coupling unit, the distance between the opposed lips being less than the width of the groove such that the opposed lips retain the optical fiber in the groove.

23. A method for assembling a portion of an optical data link, said optical data link including a coupling unit and an optical fiber, said coupling unit including a tapered well with a larger end and a smaller end and a groove extending from the well to a sidewall of the coupling unit, said method comprising the steps of:
inserting one end of the optical fiber into the larger end of the well of the coupling unit;
bending the optical fiber through about 90 degrees; and
pressing the optical fiber into the groove of the coupling unit.

24. The method for assembling a portion of an optical data link in accordance with claim 23, said method comprising the further step of:
retaining the optical fiber in the groove by providing an interference fit.

25. The method for assembling a portion of an optical data link in accordance with claim 23, wherein said tapered well has curved walls between the smaller end and the larger end, said method comprising the further step of:
controlling the curvature of the optical fiber by bending the fiber against the curved walls of the well.

26. The method for assembling a portion of an optical data link in accordance with claim 23, said method comprising the further step of:
providing a keyhole design at the smaller end of the well with said keyhole design having a larger opening and a smaller opening;
inserting the optical fiber into the larger opening of the keyhole design; and
impelling the end of the optical fiber from the larger opening into the smaller opening of the keyhole design to provide an interference fit at the end of the optical fiber during cutting or cleaving of the end of the fiber.
